(19) United States
(12) Patent Application Publication
(10) Pub. No.: US 2023/0374217 A1
(43) Pub. Date: Nov. 23, 2023

(54) Yield-optimized method for producing a polyamide powder composition

(71) Applicant: ARKEMA FRANCE, Colombes (FR)

(72) Inventors: Pierrick ROGER-DALBERT, Pierr-Benite Cedex (FR); Jean-Yves LOZE, Serquigny (FR); Eric LABONNE, Serquiny (FR)

(21) Appl. No.: 18/248,259

(22) PCT Filed: Oct. 11, 2021
(86) PCT No.: PCT/FR2021/051761

§ 371 Date: Apr. 7, 2023

(30) Foreign Application Priority Data
Oct. 9, 2020 (FR) FR2010338

(51) Int. Cl. C08G 69/46; C08G 69/04; C09D 177/02; C08G 69/16

(52) U.S. Cl. CPC C08G 69/46; C08G 69/04; C09D 177/02; C08G 69/16

(57) ABSTRACT

The present invention relates to a process for preparing a powder composition based on polyamide(s) with an optimized yield. The process includes a step of recycling a composition based on a polyamide prepolymer having a lower Dv50, by polycondensation of a mixture comprising said composition and one or more monomers in the presence of water. The invention also relates to the powder composition obtained and to the use thereof, especially for coating metal substrates by fluidized bed dip-coating.

### FIELD OF THE INVENTION

The present invention relates to a process for preparing a powder composition based on polyamide(s) with an optimized yield.

The invention also relates to the powder composition obtained and to the use thereof, especially for coating metal substrates by fluidized bed dip-coating.

### TECHNICAL BACKGROUND

It is known that it is possible to obtain a polyamide powder composition via a process of cryogenic grinding from a polymer in granule form, but the process is expensive and has a low yield.

It is also known that it is possible to obtain a polyamide powder composition via a production process in which prepolymers are ground beforehand at low viscosity, followed by a step of solid-phase polycondensation in order for the polyamide powder to reach the desired viscosity. This type of process makes it possible to obtain a crude powder from prepolymers, which are easier to grind compared to crude powder which generally has a higher viscosity. Reference may be made, for example, to the processes described in patent EP 2247646 or FR 1495816.

In general, the crude powder obtain has a relatively broad particle size distribution and especially has a significant portion of fine particles. Fine particles are defined as particles having diameters which are generally 3 times smaller than the volume-median diameter (Dv50). For example, for a powder composition having a Dv50 from 100 to 120 μm, the fine particles are those with a diameter of less than 40 μm. During the use of such a powder composition for coating metal substrates by fluidized bed dip-coating, the presence of fine particles may cause various problems. For example, fine particles flying away during the fluidization of the powder may represent a loss of approximately 8% and/or may cause a change in the particle size distribution of the powder by depleting the fine particles, degrading the applicability thereof, i.e. making it difficult to control the thickness of the coating and making it difficult to maintain a constant fluidization quality. Thus, a selection step is often required in order to eliminate these fine particles from the powder composition before it is used in a dip-coating process. This step makes it possible to provide a powder with a narrower particle size by eliminating fine particles, but generates a significant amount of loss in the form of the unusable fine particles.

This phenomenon, known as “loss” or “waste”, can also be observed when the powder composition is bulk additized. For the purposes of the present invention, “a bulk-additized powder composition” means a polymer-based powder composition comprising additives (such as pigments and antioxidants) obtained by a process of mixing in the melt state (also referred to as “compounding”) by means of which the additives are included in the powder particles.

In the context of waste reduction and energy optimization for ecological reasons, there is a need to optimize the processes to reduce losses and improve the yield, thereby making it possible to optimize the use of the starting materials and to reduce waste.

The aim of the invention is to propose a process that makes it possible to reuse the undesirable fine particles and to thereby improve the yield of the preparation process.

The invention also aims to propose a powder composition having a controlled, and preferably narrow, particle size which can be used in a process for fluidized-bed dip-coating.

### SUMMARY OF THE INVENTION

Firstly, the invention relates to a process for preparing a powder composition based on polyamide(s) (composition PA) having an inherent viscosity of greater than or equal to 0.65 (g/100 g)⁻¹ and less than or equal to 1.40 (g/100 g)⁻¹, comprising:
(i) providing a composition (i) based on polyamide prepolymer having a maximum inherent viscosity of 0.60 (g/100 g)⁻¹, which composition is, where appropriate, bulk additized;
(ii) grinding the composition (i) to obtain a powder composition (ii);
(iii) separating the composition (ii) into at least two compositions, pre-PA0 and pre-PA, which, where appropriate, are bulk additized, such that the Dv50 of pre-PA0 is less than the Dv50 of composition (ii) and that the Dv50 of pre-PA is greater than the Dv50 of composition (ii);
(iv) recycling the composition pre-PA0 which, where appropriate, is bulk additized, for the preparation of a powder composition based on polyamide(s) (composition PA1) having an inherent viscosity of greater than or equal to 0.65 (g/100 g)⁻¹ and less than or equal to 1.40 (g/100 g)⁻¹, the composition PA1 preferably being the composition PA.

Generally, the Dv50 of the composition pre-PA0 is unsatisfactory, and the Dv50 of the composition pre-PA is that which is sought depending on a desired final application.

The composition (i) is in the form of a divided solid, preferably a coarse powder of sizes less than 1 mm.

For the purposes of the present invention, “a composition based on polyamide prepolymer or a composition based on polyamide” means a composition comprising at least 50% by weight of polyamide prepolymer or of polyamide relative to the total weight of the composition.

The composition pre-PA0 preferably has a Dv50 3 times smaller than the Dv50 of the powder composition (ii).

According to a particular embodiment, the composition pre-PA0 has a Dv50 of less than 50 μm.

Thus, the present invention makes it possible to reduce losses by recycling the particles which have unsatisfactory particle size, within the same production process when the recycling step takes place in the process for preparing the composition PA, or else in a subsequent process for preparing another polyamide-based composition.

While the process of the invention is particularly beneficial for “fine” or “extrafine” prepolymer particles, typically those having a diameter of less than 50 μm, it goes without saying that all prepolymers, regardless of the particle size thereof, preferably having an inherent viscosity of less than 0.60 (g/100 g)⁻¹, can be used in the recycling step.

According to one embodiment, the polyamide in the composition PA has a melting point of less than or equal to 300° C. Preferably, the composition has a melting point of less than or equal to 250° C., more preferentially less than or equal to 200° C., for example less than or equal to 190° C.

The polyamide in the composition PA according to the invention has an inherent viscosity of greater than or equal to 0.65 (g/100 g)⁻¹ and less than or equal to 1.40 (g/100 g)⁻¹. Preferably, the inherent viscosity thereof is greater than or equal to 0.70 g/100 g)⁻¹, especially to 0.75 g/100 g)⁻¹, in particular to 0.80 (g/100 g)⁻¹ and less than or equal to 1.10 (g/100 g)⁻¹, more preferably to 1.05 (g/100 g)⁻¹, in particular to 1.0 (g/100 g)⁻¹.

The process of the present invention makes it possible to eliminate the fine particles and to recycle them during the production in order to reduce the amount of losses over the whole preparation and application process.

According to a first aspect, the step of recycling the composition pre-PA0 comprises:
(iv-1) a step of providing a mixture comprising:
   from 15% to 99.9%, preferably from 30% to 99.9% by weight relative to the total weight of the mixture, of one or more monomer(s),
   from 0.1% to 85%, preferably 0.1% to 75%, even more preferentially from 0.1% to 50% by weight relative to the total weight of the mixture, of the composition pre-PA0, which, where appropriate, is bulk additized, having an inherent viscosity of less than 0.60 (g/100 g)⁻¹, generally of less than 0.55 (g/100 g)⁻¹,
   optionally, a catalyst;
and optionally one or more filler(s) and/or additive(s);
(iv-2) a step of polycondensation of said mixture in the presence of water, by means of which a polycondensation product (also referred to as “composition pre-PA1”) is obtained.

According to one embodiment, water is added in an amount of 10% to 40%, preferably 20% to 30% by weight relative to the total weight of the mixture.

The composition pre-PA0 may comprise a polyamide prepolymer or a mixture of a plurality of polyamide prepolymers.

Preferably, the composition pre-PA0 comprises a polyamide prepolymer.

According to one embodiment, the composition pre-PA0 consists of polyamide prepolymer.

According to one embodiment, the composition pre-PA0 comprises at least 50% polyamide prepolymer(s) and one or more additives.

The inherent viscosity of the polyamide prepolymer(s) in the composition pre-PA0 is less than 0.60 (g/100 g)⁻¹, typically within the range extending from 0.25 to 0.55, preferably between 0.30 and 0.50 (g/100 g)⁻¹, even more preferentially between 0.40 and 0.50 (g/100 g)⁻¹.

The inherent viscosity of the polyamide prepolymer(s) in the composition pre-PA1 is less than 0.60 (g/100 g)⁻¹, typically within the range extending from 0.25 to 0.55, preferably between 0.30 and 0.50 (g/100 g)⁻¹, even more preferentially between 0.40 and 0.50 (g/100 g)⁻¹.

According to one beneficial embodiment, the composition pre-PA0 is a composition based on PA 11, PA 12, PA 1010, PA 1012, PA 6, PA 610, PA 612, PA 614, PA 618, PA 8, PA 9, PA 10, PA 13, PA 14 prepolymers and mixtures thereof, preferably a composition consisting of polyamide PA 11 prepolymers.

According to one embodiment, the catalyst is selected from phosphoric acid and/or hypophosphorous acid.

The catalyst is typically in the form of an aqueous solution.

According to a preferential embodiment, the one or more monomers are selected from amino acids, lactams, preferably selected from aminocaproic acid, 7-aminoheptanoic acid, 8-aminooctanoic acid, 9-aminononanoic acid, 10-aminodecanoic acid, 11-aminoundecanoic acid, 12-aminododecanoic acid, 13-aminotridecanoic acid, 14-aminotetradecanoic acid and/or mixtures thereof, preferably 11-aminoundecanoic acid.

According to a particular embodiment, the one or more monomers is a mixture of diamine monomers and diacid monomers, preferably a mixture of diamine monomers such as hexamethylenediamine, decanediamine, dodecamethylenediamine, meta-xylylenediamine, bis-p-aminocyclohexylmethane and trimethylhexamethylenediamine with diacid monomers such as isophthalic, terephthalic, adipic, azelaic, suberic, sebacic, dodecanedioic, tetradecanedioic acids and/or mixtures thereof.

According to one embodiment, a monomer is introduced that corresponds to the monomer unit of the polyamide (PA) having an inherent viscosity of less than 0.60. For example, it is possible to provide a mixture of 11-aminoundecanoic monomers with a polyamide 11 prepolymer. Alternatively, for example, it is possible to choose a mixture of a 12-aminododecanoic monomer with a polyamide 12 prepolymer.

Nevertheless, it is also possible to introduce a monomer different from the monomer unit of the polyamide. For example, it is possible to provide a mixture of 12-aminododecanoic as monomers and a composition PA0 based on polyamide 11 prepolymer in order to obtain a composition pre-PA1 based on copolyamide 11/12.

The solid-state polycondensation step is carried out at a temperature above the glass transition temperature and below the melting point of the polyamide.

The reaction is advantageously carried out in an inert atmosphere, under nitrogen or under vacuum, for example. The reaction time needed to reach the expected inherent viscosity depends on the temperature selected; this may be established by simple routine tests. Advantageously, this step may be carried out in a drier.

It has been observed, under the specific conditions of the present invention, that, during the polycondensation step, chemical equilibrium is established, which makes it possible at the end of the prepolymerization to obtain a distribution of the molecular weights of the polyamide prepolymer(s) similar to a process using solely monomers as starting materials.

A specific process is therefore proposed, comprising a step in which the prepolymers, especially those having a fine particle size, are mixed with monomers as reagents that participate in the polycondensation reaction.

According to this aspect of the invention, step (iv) comprises all or at least one of the following steps, in succession:
(iv-3) a step of cooling the composition pre-PA1.

According to one embodiment, the cooled composition pre-PA1 is passed into a pelletizer or a grinding mill, which reduces it to a coarse powder, typically having a mean diameter of less than 5 mm, before the following steps.
(iv-4) optionally, a step of mixing in the melt state so as to add additives such as pigments and antioxidants into the composition pre-PA1, by means of which the bulk-additized composition pre-PA1 is obtained.

The step of mixing in the melt state consists in mixing, in the molten phase, the polycondensation product in the melt state with additives, for example, by means of twin screws in a heated barrel. The mixture is then extruded through a die to a cooled roll mill in which the mixture solidifies, or else using a calendar.

The temperature applied during the mixing step must slightly exceed the prepolymer melting point. Typically, the temperature applied is at most 5° C. greater than the prepolymer melting point.

Typically, the residence time is less than 1 minute.

According to a particular embodiment, it is possible to mix, in addition to the composition pre-PA1 and one or more additives, a composition pre-PA0, preferably those having a fine particle size, typically of less than 40 μm. According to one embodiment, the bulk-additized composition pre-PA1 is passed into a pelletizer or a grinding mill, which reduces it to a coarse powder, typically having a mean diameter of less than 5 mm, before the following steps.
(iv-5) a step of grinding and optionally selecting the cooled composition pre-PA1 which, where appropriate, is bulk additized.

The grinding is preferably mechanical grinding carried out at ambient temperature.

The grinding may be carried out in an impact mill, for example a hammer mill, a knife mill, a disk mill or an air-jet mill, preferably provided with an internal classifier.

The particle size of the composition pre-PA1 is controlled directly by adjusting the grinding speed; preferably, the adjustment is also carried out by means of a classifier integrated in the grinding mill.

The optional selection step makes it possible to separate the ground composition pre-PA1 into at least 2 compositions, one of which has a desired Dv50. The composition with an unsatisfactory Dv50 can be recycled again into the process of the invention.

Thus, the process of the invention makes it possible to recycle unusable materials several times if necessary, making it possible to minimize losses during production.

The process according to the invention can comprise:
(v) a step of increasing the viscosity of the composition pre-PA1 obtained after the one or more steps described above, optionally mixed with the composition pre-PA, until the final desired viscosity for the powder composition based on polyamide(s), preferably carried out by solid-phase polycondensation in a drier.
(vi) optionally, a step of dry mixing the powder composition based on polyamide(s) with additives, such as pigments and antioxidants, the additives preferably having a similar particle size to that of the powder composition based on polyamide(s).

According to another aspect of the present invention, the step (iv) of recycling the composition pre-PA0 comprises a step of mixing in the melt state (also referred to as compounding) of the composition pre-PA0 which, where appropriate, is bulk additized, as defined above, optionally mixed with a composition of polyamide prepolymers and/or additives, under conditions such that melt-phase polycondensation during this step is limited, by means of which a bulk-additized composition based on prepolymer(s) (composition pre-PA1′) is obtained.

The step of mixing in the melt state consists in mixing, in the molten phase, the composition pre-PA0, optionally with a composition of polyamide prepolymers and/or additives, for example, by means of twin screws in heated barrels. The mixture is then extruded through a die to a cooled roll mill in which the mixture solidifies, or else using a calendar.

The temperature applied during the mixing step must slightly exceed the prepolymer melting point. Typically, the temperature applied is at most 5° C. greater than the prepolymer melting point.

Typically, the residence time is less than 1 minute.

It has been observed that, during this step, the polycondensation reaction is negligible and does not lead to any apparent change in the viscosity of the prepolymers. Thus, this process proposes a highly simple method for recycling these prepolymers with an unsatisfactory Dv.

The composition pre-PA1′ can be passed into a pelletizer or a grinding mill, which reduces it to a coarse powder, typically having a mean diameter of less than 5 mm.

According to one embodiment, the recycling step (iv) comprises a step of grinding and optionally selecting the cooled composition pre-PA1′.

The grinding is mechanical grinding, which may be cryogenic or carried out at ambient temperature.

The grinding may be carried out in an impact mill, for example a hammer mill, a knife mill, a disk mill or an air-jet mill, preferably provided with an internal selector.

The particle size of the composition pre-PA1′ is controlled directly by adjusting the grinding speed, preferably by means of a classifier integrated in the grinding mill.

The optional selection step makes it possible to separate the ground composition pre-PA1′ into at least 2 compositions, one of which has a desired Dv50. The composition with an unsatisfactory Dv50 can be recycled again into the process of the invention.

Thus, the process of the invention makes it possible to recycle unusable materials several times if necessary, making it possible to minimize losses during production.

According to this aspect of the invention, the process for preparing the powder composition based on polyamide (composition PA) may comprise all or at least one of steps (v) and (vi) as described below.

Thus, the present invention makes it possible to reuse the prepolymers, or a composition comprising the prepolymers, having an unsatisfactory particle size as reagents in a production process, to greatly limit losses of starting materials which may extend from production to final use, in particular for application as a coating by fluidized-bed dip-coating.

The present invention also proposes a powder composition based on polyamide(s) (PA) having a controlled particle size, preferably a narrow and more uniform particle size, while reducing material losses during the process for preparing same.

According to one aspect, the invention relates to a powder composition based on polyamide(s), entirely or partially resulting from a process as described above, wherein the polyamide has an inherent viscosity of 0.65 to 1.40 (g/100 g)⁻¹, preferably from 0.70 to 1.10 (g/100 g)⁻¹, even more preferentially from 0.80 to 1.00 (g/100 g)⁻¹ and preferably having a volume-diameter Dv50 of between 80 and 130 μm, even more preferentially of between 90 and 120 μm, or else of between 100 and 110 μm.

According to one embodiment, the powder composition comprises additives, and is preferably bulk additized.

The invention also relates to the use of the composition as defined above in a process for coating metal substrates by fluidized-bed dip-coating.

Although this composition is particularly suitable for coatings prepared by a process of fluidized-bed dip-coating, the composition can also be used in other fields.

Thus, the invention relates to the use of the composition as defined above in paints, corrosion-resistant compositions, paper additives, powder agglomeration technologies using radiation-induced fusion or sintering to manufacture objects, electrophoresis gels, multilayer composite materials, the packaging industry, toys, textiles, the automotive industry and/or the electronics industry.

### DETAILED DESCRIPTION

### Definition

The term “prepolymer” refers to a prepolymer for which the inherent viscosity is less than 0.60 (g/100 g)⁻¹.

The term “inherent viscosity” refers to the viscosity of a polymer in solution, determined via measurements in an Ubbelohde tube. The measurement is carried out on a 75 mg sample at a concentration of 0.5% (m/m) in m-cresol. The inherent viscosity, expressed in (g/100 g)⁻¹, is calculated according to the following formula: Inherent viscosity=ln(ts/to)×1/C, with C=m/p×100, in which ts is the flow time of the solution, to is the flow time of the solvent, m is the mass of the sample whose viscosity is being determined, and p is the mass of the solvent. This measurement is carried out according to standard ISO 307 but with a measuring temperature of 20° C. rather than 25° C. The viscosity of a composition comprising the polymer plus any additives insoluble in m-cresol is determined by increasing the sample quantity so that the solution has a polymer concentration of 0.5% (m/m).

The term “melting point” is intended to denote the temperature at which an at least partially crystalline polymer changes to the viscous liquid state, as measured by differential scanning calorimetry (DSC) according to the standard NF EN ISO 11 357-3 using a heating rate of 20° C./min.

The term “glass transition temperature” is intended to denote the temperature at which an at least partially amorphous polymer changes from a rubbery state to a glassy state, or vice versa, as measured by differential scanning calorimetry (DSC) according to the standard NF EN ISO 11 357-2 using a heating rate of 20° C./min.

Furthermore, the term “volume-average diameter” or “Dv” is intended to refer to the volume-average diameter of a pulverulent substance, as measured according to standard ISO 9276—parts 1 to 6: “Representation of results of particle size analysis”. Various diameters are differentiated. More specifically, the Dv50 denotes the volume-median diameter, i.e. that which corresponds to the 50^{th} volume percentile, and the Dv10 and Dv90 denote respectively the volume-average diameters below which are 10% or 90% by volume of the particles. The volume-average diameter may be measured especially by means of a laser particle size analyzer, for example a laser particle size analyzer (Sypmatec Helos). Software (Fraunhofer) can then be used to obtain the volumetric distribution of a powder and deduce the Dv10, Dv50 and Dv90 therefrom.

### “Polyamide”

The nomenclature used to define polyamides is described in the standard ISO 1874-1:1992 “Plastics—Polyamide moulding and extrusion materials—Part 1: Designation”, in particular on page 3 (tables 1 and 2), and is well known to those skilled in the art.

The polyamide can be aliphatic, semiaromatic and cycloaliphatic.

The polyamide can be selected from a homopolyamide, a copolyamide, and mixtures thereof.

It can also be a blend of polyamide and of at least one other polymer, the polyamide forming the matrix and the other polymer(s) forming the dispersed phase.

Within the meaning of the invention, the term “polyamide” is understood to mean the condensation products:
of one or more amino acid monomers, such as aminocaproic acid, aminocaproic acid, 7-aminoheptanoic acid, 8-aminooctanoic acid, 9-aminononanoic acid, 10-aminodecanoic acid, 11-aminoundecanoic acid, 12-aminododecanoic acid, 13-aminotridecanoic acid, 14-aminotetradecanoic acid and one or more lactam monomers such as caprolactam, enantholactam and lauryllactam;
of one or more salts or mixtures of diamine monomers, such as hexamethylenediamine, decanediamine, dodecamethylenediamine, meta-xylylenediamine, bis(p-aminocyclohexyl)methane and trimethylhexamethylenediamine, with diacids, such as isophthalic acid, terephthalic acid, adipic acid, azelaic acid, suberic acid, sebacic acid, dodecanedioic acid and tetradecanedioic acid.

The polyamide can be a copolyamide. Mention may be made of copolyamides resulting from the condensation of at least two different monomers, for example of at least two different α,ω-aminocarboxylic acids or of two different lactams or of a lactam and of an α,ω-aminocarboxylic acid with a different carbon number. Mention may also be made of copolyamides resulting from the condensation of at least one α,ω-aminocarboxylic acid (or one lactam), at least one diamine and at least one dicarboxylic acid. Mention may also be made of copolyamides resulting from the condensation of an aliphatic diamine with an aliphatic dicarboxylic acid and at least one other monomer chosen from aliphatic diamines other than the preceding one and aliphatic diacids other than the preceding one.

In the present description, the term “monomer” should be taken as meaning “repeat unit”. A special case is where a repeat unit of the polyamide consists of the combination of a diacid with a diamine. It is considered that it is the combination of a diamine and of a diacid, that is to say the “diamine-diacid” pair, also referred to as “XY” pair, in equimolar amounts, which corresponds to the monomer. This is explained by the fact that, individually, the diacid or the diamine is only a structural unit, which is not sufficient by itself alone to form a polymer.

Mention may be made, by way of example of diamine X, of aliphatic diamines having from 6 to 12 atoms, it also being possible for the diamine X to be aryl and/or saturated cyclic. Mention may be made, by way of examples, of hexamethylenediamine, piperazine, tetramethylenediamine, octamethylenediamine, decamethylenediamine, dodecamethylenediamine, 1,5-diaminohexane, 2,2,4-trimethyl-1,6-diaminohexane, polyol diamines, isophoronediamine (IPD), methylpentamethylenediamine (MPMD), bis(aminocyclohexyl)methane (BACM), bis(3-methyl-4-aminocyclohexyl)methane (BMACM), meta-xylylenediamine, bis(p-aminocyclohexyl)methane and trimethylhexamethylenediamine.

Mention may be made, by way of example of diacid (or dicarboxylic acid) Y, of acids having between 4 and 18 carbon atoms. Mention may be made, for example, of adipic acid, sebacic acid, azelaic acid, suberic acid, dodecanedioic acid, tetradecanedioic acid, isophthalic acid, butanedioic acid, 1,4-cyclohexanedicarboxylic acid, terephthalic acid, the sodium or lithium salt of 5-sulfoisophthalic acid or dimerized fatty acids (these dimerized fatty acids have a dimer content of at least 98% and are preferably hydrogenated).

The lactam or amino acid monomers are said to be of “Z” type.

Mention may be made, by way of example of lactams, of those having from 3 to 12 carbon atoms on the main ring and which can be substituted. Mention may be made, for example, of β,β-dimethylpropiolactam, α,α-dimethylpropiolactam, amylolactam, caprolactam, capryllactam, enantholactam, 2-pyrrolidone and lauryllactam.

Mention may be made, by way of example of amino acid, of α,ω-amino acids, such as aminocaproic acid, 7-aminoheptanoic acid, 11-aminoundecanoic acid, n-heptyl-11-aminoundecanoic acid and 12-aminododecanoic acid.

According to one embodiment, the polyamide (PA) according to the invention comprises at least one polyamide or one polyamide block selected from polyamides and copolyamides comprising at least one of the following monomers: 46, 4T, 54, 59, 510, 512, 513, 514, 516, 518, 536, 6, 64, 66, 69, 610, 612, 613, 614, 616, 618, 636, 6T, 9, 10, 104, 109, 1010, 1012, 1013, 1014, 1016, 1018, 1036, 10T, 11, 12, 124, 129, 1210, 1212, 1213, 1214, 1216, 1218, 1236, 12T, MXD6, MXD10, MXD12, MXD14, and mixtures thereof.

Preferably, the polyamides (PA) comprise at least one polyamide selected from polyamides and copolyamides comprising at least one of the following XY or Z monomers: 59, 510, 512, 514, 6, 69, 610, 612, 614, 109, 1010, 1012, 1014, 10T, 11, 12, 129, 1210, 1212, 1214, 12T, MXD6, MXD10, MXD12, MXD14, and mixtures thereof; in particular selected from PA 11, PA 12, PA 1010, PA 1012, PA 6, PA 610, PA 612, PA 614, PA 618 and mixtures thereof.

Mention may be made, by way of examples of copolyamides, of PA 6/12, PA 6/66, PA 6/12/66, PA 6/69/11/12, PA 6/66/11/12, PA 69/12 or PA 11/10T.

### Fillers and Additives

### Additives

Mention may be made, by way of examples of additives, of one or more pigments or dyes.

The pigment may in principle be freely selected from conventionally used pigments. It may especially be selected from inorganic pigments such as titanium dioxide, carbon black, cobalt oxide, nickel titanate, molybdenum bisulfide, aluminum flakes, iron oxides, zinc oxide, zinc phosphate, and organic pigments, such as phthalocyanine and anthraquinone derivatives.

The dye may also be of any type known to those skilled in the art. Mention may be made in particular of azo dyes, anthraquinonoid dyes, indigo-derived dyes, triarylmethane dyes, chlorine dyes and polymethine dyes.

Mention may also be made of one or more additives selected from the group consisting of anti-crater agents or spreading agents, reducing agents, antioxidants, reinforcing fillers, UV stabilizers, fluidizing agents and corrosion inhibitors, or mixtures thereof.

The anti-crater agent and/or spreading agent may be of any type known to those skilled in the art. Preferably, the anti-crater agent and/or spreading agent is selected from the group consisting of polyacrylate derivatives.

The UV stabilizer may be of any type known to those skilled in the art. Preferably, the UV stabilizer is selected from the group consisting of resorcinol derivatives, benzotriazoles, phenyltriazines and salicylates.

The antioxidants may be of any type known to those skilled in the art. Preferably, the antioxidants are selected from the group consisting of copper iodide combined with potassium iodide, phenol derivatives and hindered amines.

The fluidizing agent may be of any type known to those skilled in the art. Preferably, the fluidizing agent is selected from the group consisting of aluminas and silicas.

The corrosion inhibitors may be of any type known to those skilled in the art. Preferably, the corrosion inhibitors are selected from the group consisting of phosphosilicates and borosilicates.

The additives are preferably present in a quantity by mass, relative to the total mass of the composition, of 1 to 30%, more preferentially from 2 to 10%, even more preferentially from 3 to 5%, for example from 0 to 5%, or from 5 to 10%, or from 10 to 15%, or from 15 to 20%, or from 20 to 25%, or from 25 to 30%.

### Fillers

The reinforcing filler may be of any type that is suitable for preparing polyamide-based powders. However, it is preferable for the filler to be selected from the group consisting of talc, calcium carbonates, manganese carbonates, potassium silicates, aluminum silicates, dolomite, magnesium carbonates, quartz, boron nitride, kaolin, wollastonite, titanium dioxide, glass beads, mica, carbon black, mixtures of quartz, mica and chlorite, feldspar and dispersed nanometric fillers such as carbon nanotubes and silica. The filler is particularly preferably calcium carbonate.

The fillers are preferably present in a quantity by mass, relative to the total mass of the composition, of 0 to 50%, more preferentially from 0 to 10%, even more preferentially from 0 to 5%, for example from 0 to 5%, or from 5 to 10%, or from 10 to 15%, or from 15 to 20%, or from 20 to 25%, or from 25 to 30%.

### EXAMPLES

The following examples illustrate the invention without limiting it.

### Example 1

1.1 70% by weight of 11-aminoundecanoic acid and 30% by weight of a fine (Dv50=32 μm) polyamide 11 prepolymer powder (referred to as “powder pre-PA0”), the inherent viscosity of which is 0.40, are loaded into an autoclave with 30% water by weight relative to the mixture of 11-aminoundecanoic acid and the prepolymer powder, with addition of phosphoric acid. The mixture is heated a temperature of approximately 190° C. under a pressure of 10 bar. The water is distilled and the reactor is degassed. The vapor taken off is recondensed and weighed. The amount of vapor removed is monitored until a certain amount of vapor has been removed, which corresponds to the viscosity desired for the prepolymer. The prepolymer having a viscosity of 0.40 is then drained. At the draining valve, the prepolymer is still molten, then it cools when in contact between two cold metal rollers, and is solidified. The solidified prepolymer is then passed into a pelletizer or a grinding mill, which reduces it to a coarse powder having a mean diameter of less than 5 mm. The experiment was repeated 3 times to obtain prepolymers having viscosities of 0.39/0.42/0.40 (g/100 g)⁻¹.

1.2 A test was carried out following the same protocols in example 1.1, where the mixture of 11-aminoundecanoic acid and the powder pre-PA0 was replaced by 100% by weight of 11-aminoundecanoic acid monomers. The experiment was repeated 3 times to obtain prepolymers having viscosities of 0.40/0.39/0.41 (g/100 g)⁻¹.

Inherent viscosity analyses show that the two products of examples 1.1 and 1.2 have a virtually identical viscosity.

Gel permeation chromatography (GPC) analyses were carried out. It was observed that, in addition to identical prepolymer viscosities, the chain length distribution with (example 1.1) or without (example 1.2) recycling the fine powders is similar. In addition, there are no bi-populations of molecular weight. This is reflected by an Mn (number-average molecular weight), an Mw (weight-average molecular weight) and a PI (polydispersity index: Mw/Mn) that are identical.

This demonstrates that a prepolymer produced from the recycling of prepolymers is identical to the prepolymer produced from monomers.

### Example 2

2.1 The coarse powder obtained in example 1.1 is ground in a hammer mill provided with an internal classifier. The crude ground powder thus obtained is separated in a cyclone classifier, making it possible to obtain 2 powders:
a powder (“powder pre-PA0a”), having Dv50=32 μm (˜8% by weight of the crude powder),
a powder (“powder pre-PA”), having Dv50=111 μm (˜92% by weight of the crude powder).

2.2 A Powder Obtained by Cryogenically Grinding Granules of Polyamide 11 (Cryogenically Ground Powder)

The particle sizes of the powder pre-PA (powder according to the invention) and the cryogenically ground powder are presented in FIG. 1.

The cryogenically ground powder has a proportion of fine particles having a size of less than 50 μm that is much greater than the powder of the present invention—approximately 5% for the cryogenically ground powder, as opposed to less than 0.3% for the powder of the present invention.

The cryogenically ground powder also has a proportion of large particles having a size of greater than 300 μm that is much greater—approximately 8% for the cryogenically ground powder, as opposed to approximately 1% for the powder of the present invention.

Thus, the powder of the present invention has two main advantages for use in fluidized-bed dip-coating:
The low proportion of particles >250 μm makes it possible to reduce the fluidization rate (see example 4),
The low proportion of fines <50 μm, as well as a low fluidization rate, makes it possible to limit flyaway of fines.

Consequently, while a cryogenically ground powder loses up to 5% of its material during fluidization, the powder of the present invention makes it possible to limit this loss to less than 0.1%.

This also makes it possible to maintain a constant quality of application.

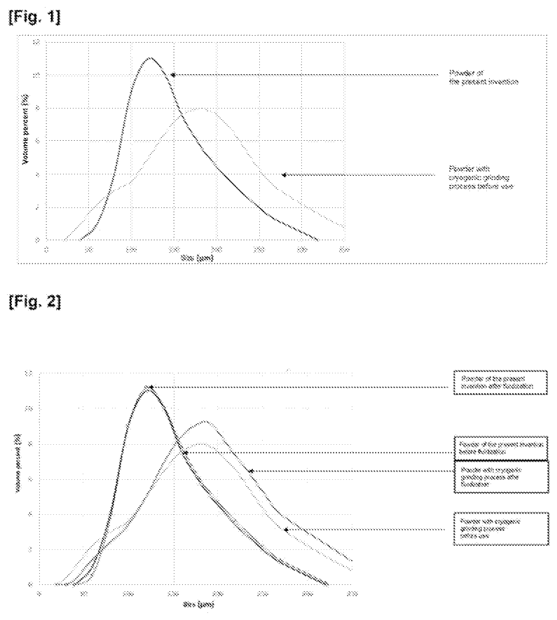

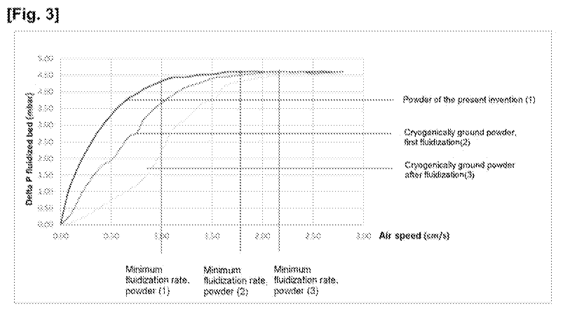

FIG. 2 shows changes in particle size caused by fluidization:

The change in the particle size of a cryogenically ground powder is significant, whereas the powder of the present invention is stable. Consequently, the quality of application of the present invention is stable.

This stability in the quality of application of the product makes it possible to reuse the powder of the present invention after numerous dip-coating operations, while cryogenically ground powder would have to be refreshed with virgin powder. The present invention makes it possible to reduce the amount of waste generated by this refreshing of product by approximately 5%.

### Example 3

FIG. 3 presents the delta P profile as a function of the air speed for a powder bed. When an increase in the air speed does not cause an increase in the pressure loss (delta P), this means that the powder is fluidized.

The “virgin” cryogenically ground powder, i.e. powder for a first fluidization, shows that the minimum fluidization rate is approximately 1.8 m/s, while the powder of the present invention requires 1.0 m/s for fluidization thereof.

This difference is due to the narrower particle size distribution and especially the lower proportion of particles >250 μm.

This lower rate makes it possible in particular to reduce losses due to the flyaway of fines (5% losses) and consequently to stabilize the quality of the product which does not require refreshing (reduction of 5% in losses).

1. A process for preparing a powder composition based on polyamide(s) (composition PA) having an inherent viscosity of greater than or equal to 0.65 (g/100 g)⁻¹ and less than or equal to 1.40 (g/100 g)⁻¹, comprising:
(i) providing a composition (i) based on polyamide prepolymer having a maximum inherent viscosity of 0.60 (g/100 g)⁻¹, which composition is, where appropriate, bulk additized;
(ii) grinding the composition (i) to obtain a powder composition (ii);
(iii) separating the composition (ii) into at least two compositions, pre-PA0 and pre-PA, which, where appropriate, are bulk additized, such that the Dv50 of pre-PA0 is less than the Dv50 of composition (ii) and that the Dv50 of pre-PA is greater than the Dv50 of composition (ii);
(iv) recycling the composition pre-PA0 which, where appropriate, is bulk additized, for the preparation of a powder composition based on polyamide(s) (composition PA1) having an inherent viscosity of greater than or equal to 0.65 (g/100 g)⁻¹ and less than or equal to 1.40 (g/100 g)⁻¹.

2. The process as claimed in claim 1, wherein the step of recycling the composition pre-PA0 comprises:
(iv-1) a step of providing a mixture comprising:
from 15 to 99.9% by weight relative to the total weight of the mixture, of one or more monomer(s),
from 0.1 to 85% by weight relative to the total weight of the mixture, of the composition pre-PA0, which, where appropriate, is bulk additized, having an inherent viscosity of less than 0.60 (g/100 g)⁻¹,
optionally, a catalyst;
and optionally one or more filler(s) and/or additive(s);
(iv-2) a step of polycondensation of said mixture in the presence of water, by means of which a polycondensation product (“composition pre-PA1”) is obtained.

3. The process as claimed in claim 2, wherein water is added in an amount of 10 to 40% by weight relative to the total weight of the mixture.

4. The process as claimed in claim 1, wherein the composition pre-PA0 consists of polyamide prepolymer or comprises at least 50% polyamide prepolymer(s) and one or more additives.

5. The process as claimed in claim 1, wherein the inherent viscosity of the polyamide prepolymer(s) in the composition pre-PA0 and in the composition pre-PA1 is less than 0.60 (g/100 g)⁻¹, typically within the range extending from 0.25 to 0.55 (g/100 g)⁻¹.

6. The process as claimed in claim 1, wherein the composition pre-PA0 is a composition based on prepolymer PA 11, PA 12, PA 1010, PA 1012, PA 6, PA 610, PA 612, PA 614, PA 618, PA 8, PA 9, PA 10, PA 13, PA 14 prepolymers and mixtures thereof.

7. The process as claimed in claim 1, wherein the one or more monomers are selected from amino acids, lactams, aminocaproic acid, 7-aminoheptanoic acid, 8-aminooctanoic acid, 9-aminononanoic acid, 10-aminodecanoic acid, 11-aminoundecanoic acid, 12-aminododecanoic acid, 13-aminotridecanoic acid, 14-aminotetradecanoic acid and/or mixtures thereof, a mixture of diamine monomers and diacid monomers, hexamethylenediamine, decanediamine, dodecamethylenediamine, meta-xylylenediamine, bis-p-aminocyclohexylmethane and trimethylhexamethylenediamine with diacid monomers and/or mixtures thereof.

8. The process as claimed in claim 1, wherein step (iv) comprises all or at least one of the following steps, in succession:
(iv-3) a step of cooling the composition pre-PA1;
(iv-4) optionally, a step of mixing in the melt state so as to add additives such as pigments and antioxidants into the composition pre-PA1, by means of which the bulk-additized composition pre-PA1 is obtained;
(iv-5) a step of grinding and optionally selecting the cooled composition pre-PA1 which, where appropriate, is bulk additized.

9. The process as claimed in claim 2, comprising:
(v) a step of increasing the viscosity of the composition pre-PA1, optionally mixed with the composition pre-PA, until the final desired viscosity for the powder composition based on polyamide(s);
(vi) optionally, a step of dry mixing the powder composition based on polyamide(s) with additives, such as pigments and antioxidants.

10. The process as claimed in claim 1, wherein the recycling step (iv) comprises a step of mixing in the melt state of the composition pre-PA0 which, where appropriate, is bulk additized, optionally mixed with a composition of polyamide prepolymers and/or additives, under conditions such that melt-phase polycondensation during this step is limited, by means of which a bulk-additized composition based on prepolymer(s) (composition pre-PA1′) is obtained.

11. The process as claimed in claim 10, wherein step (iv) comprises a step of grinding and optionally selecting the cooled composition pre-PA1′.

12. The process as claimed in claim 10 or 11, comprising:
(v) a step of increasing the viscosity of the composition pre-PA1′, optionally mixed with the composition pre-PA, until the final desired viscosity for the powder composition based on polyamide(s);
(vi) optionally, a step of dry mixing the powder composition based on polyamide(s) with additives, such as pigments and antioxidants.

13. A powder composition based on polyamide(s) (composition PA), entirely or partially resulting from a process as claimed in claim 1, wherein the polyamide has an inherent viscosity of 0.65 to 1.40 (g/100 g)⁻¹.

14. The composition as claimed in claim 13, comprising additives.

15. The use of the composition as claimed in claim 13 in a process for coating metal substrates by fluidized-bed dip-coating.

16. The use of the powder composition as claimed in claim 13 in paints, corrosion-resistant compositions, paper additives, powder agglomeration technologies using radiation-induced fusion or sintering to manufacture objects, electrophoresis gels, multilayer composite materials, the packaging industry, toys, textiles, the automotive industry and/or the electronics industry.
